(19) United States
(12) Patent Application Publication
(10) Pub. No.: US 2024/0351220 A1
(43) Pub. Date: Oct. 24, 2024

(54) SOFT GRIPPER CAPABLE OF GRIPPING TARGETS HAVING VARIOUS DIAMETERS, AND ROBOT SYSTEM HAVING THE SAME

(71) Applicant: KOREA INSTITUTE OF SCIENCE AND TECHNOLOGY, Seoul (KR)

(72) Inventors: Jeongryul KIM, Seoul (KR); Keri KIM, Seoul (KR); Hong Jun CHO, Seoul (KR); Sang Kyung KIM, Seoul (KR)

(73) Assignee: KOREA INSTITUTE OF SCIENCE AND TECHNOLOGY, Seoul (KR)

(21) Appl. No.: 18/328,094

(22) Filed: Jun. 2, 2023

(30) Foreign Application Priority Data
Apr. 21, 2023 (KR) 10-2023-0052548

(51) Int. Cl. B25J 15/00; B25J 9/10

(52) U.S. Cl. CPC B25J 15/0028; B25J 9/1045

(57) ABSTRACT

A gripper for gripping a target has a first support section, a second support section spaced apart from the first support section in a direction of a rotation center axis, and a plurality of elastic wires supported across the first support section and the second support section. A first grip area surrounded by the plurality of elastic wires is formed between the first support section and the second support section upon a relative rotation of the first support section and the second support section around the rotation center axis, and the first grip area becomes narrower until all the plurality of elastic wires come into contact with the target by the relative rotation of the first support section and the second support section, and the plurality of elastic wires is tightened to grip the target entering the first grip area.

### CROSS-REFERENCE TO RELATED APPLICATIONS

This application claims priority to Korean Patent Application No. 10-2023-0052548 filed on Apr. 21, 2023, in the Korean Intellectual Property Office, and all the benefits accruing therefrom under 35 U.S.C. § 119, the entire disclosure of which is incorporated herein by reference for all purposes.

### BACKGROUND

### 1. Field

The present disclosure relates to a gripper and a robot system having the same, and more particularly, to a soft gripper for gripping targets of various diameters and a robot system having the same.

### DESCRIPTION OF GOVERNMENT-FUNDED RESEARCH AND DEVELOPMENT

This research is conducted by Korea Institute of Science and Technology, and funded by Convergence Research Group project of National Research Council of Science & Technology, Ministry of Science and ICT, Republic of Korea (Development of high-risk disaster medical and industrial emergency response technologies, No. 1711177208).

### 2. Description of the Related Art

With the pandemic, the importance of non-contact medical activities using robots is emerging.

A typical example of medical activities is a specimen collection process of collecting a specimen by inserting a swab into a subject's nasal cavity or oral cavity to determine respiratory diseases caused by bacterial or viral infections.

When a medical staff directly contacts the subject to collect the specimen, secondary infection may occur to the medical professional in the specimen collection process. Additionally, testing a large number of subjects causes accumulated fatigue of the medical staff during the pandemic.

To address this problem, some non-contact specimen collection robot systems using robots have been proposed.

Since the specimen collection robot system is configured to collect the specimen while moving a swab S and a tube (“a reagent tube”) containing a reagent or controlling the position, a proper gripper for gripping the corresponding target is necessary.

Furthermore, since the specimen collection robot system collects the specimen from the human body, a soft gripper is necessary to avoid injury or discomfort to the subject.

However, the gripper for gripping the thin and long swab is a socket-type insert gripper, and the gripper for gripping the reagent tube is an electric plier gripper.

These hard grippers fail to grip precisely and softly as humans do, causing injury or discomfort to the subject.

Additionally, since different types of grippers are used to grip the swab and the reagent tube, at least two robotic arms are necessary, which requires complex configuration of the robot system and much space.

### SUMMARY

The present disclosure is directed to providing a soft gripper for gripping targets of various diameters and a robot system having the same.

According to an aspect of the present disclosure, there is provided a gripper for gripping a target, including: a first support section, a second support section spaced apart from the first support section in a direction of a rotation center axis, and a plurality of elastic wires supported across the first support section and the second support section, wherein a first grip area surrounded by the plurality of elastic wires is formed between the first support section and the second support section upon a relative rotation of the first support section and the second support section around the rotation center axis, and the first grip area becomes narrower until all the plurality of elastic wires comes into contact with the target by the relative rotation of the first support section and the second support section, and the plurality of elastic wires is tightened to grip the target entering the first grip area.

According to an embodiment, the gripper further includes a third support section spaced apart from the second support section on a side opposite to the first support section, wherein the plurality of elastic wires is supported across the first support section, the second support section and the third support section, a second grip area surrounded by the elastic wires is formed between the second support section and the third support section upon a relative rotation of the second support section and the third support section around the rotation center axis, and the second grip area becomes narrower until all the plurality of elastic wires comes into contact with the target by the relative rotation of the second support section and the third support section, and the plurality of elastic wires is tightened to grip the target entering the second grip area.

According to an embodiment, a center of the first grip area and a center of the second grip area are disposed on the rotation center axis, and the target is centrally aligned on the rotation center axis, and the target is gripped with a lengthwise direction aligned vertically in parallel to the rotation center axis.

According to an embodiment, the second support section rotates relative to the first support section and the third support section in stationary state upon rotating.

According to an embodiment, each elastic wire is extended in a straight line at an initial position, when viewed in a direction facing the rotation center axis in a radial direction of the gripper, and each elastic wire is supported in tight state at the initial position.

According to an embodiment, the second support section is rotatable 180° or more relative to the first support section and the third support section from the initial position.

According to an embodiment, the second support section further rotates a predetermined angle after all the plurality of elastic wires comes into contact with the target, to wind the plurality of elastic wires around the target to increase a gripping force.

According to an embodiment, the gripper further includes a plurality of tension sensors to detect tension acting on the plurality of elastic wires, respectively, wherein a size and direction of an external force acting on the target is detected by summing the tension detected by the plurality of tension sensors.

According to an embodiment, the tension sensor is a load cell connected to a support point at which an end of each of the plurality of elastic wires is fixed in the first support section.

According to an embodiment, a radius of a first support area defined in the first support section, a radius of a second support area defined in the second support section, and a radius of a third support area defined in the third support section are different.

According to an embodiment, a distance between the first support section and the second support section and a distance between the second support section and the third support section are different.

According to another aspect of the present disclosure, there is provided a robot system including the gripper, an end effector connected to the gripper to change a pose and position of the gripper, and a robotic arm in which the end effector is mounted at a tip.

### BRIEF DESCRIPTION OF THE DRAWINGS

FIG. 1 is a perspective view of a gripper according to an embodiment.

FIG. 2 is a side cross-sectional view of a gripper according to an embodiment.

FIG. 3 is a top view of a gripper according to an embodiment.

FIG. 4 is a conceptual diagram showing a conceptual configuration of a gripper according to an embodiment in initial state.

FIG. 5 is a top view of a gripper according to an embodiment when a second support section is rotated by 120° from initial state.

FIG. 6 is a conceptual diagram showing a conceptual configuration of a gripper according to an embodiment when a second support section is rotated by 120° from initial state.

FIG. 7 is a top view of a gripper according to an embodiment when a second support section is rotated by 180° from initial state.

FIG. 8 is a conceptual diagram showing a conceptual configuration of a gripper according to an embodiment when a second support section is rotated by 180° from initial state.

FIG. 9 is a top view of a gripper according to an embodiment when a second support section is rotated by 240° from initial state.

FIG. 10 shows that a gripper according to an embodiment grips a swab.

FIG. 11 shows an example of a robot system using a gripper according to an embodiment.

### DETAILED DESCRIPTION

Hereinafter, exemplary embodiments of the present disclosure will be described with reference to the accompanying drawings. The embodiments of the present disclosure are described with reference to the embodiments shown in the drawings, but this is described as an embodiment, and the technical spirit of the present disclosure and the essential components and operations are not limited thereto.

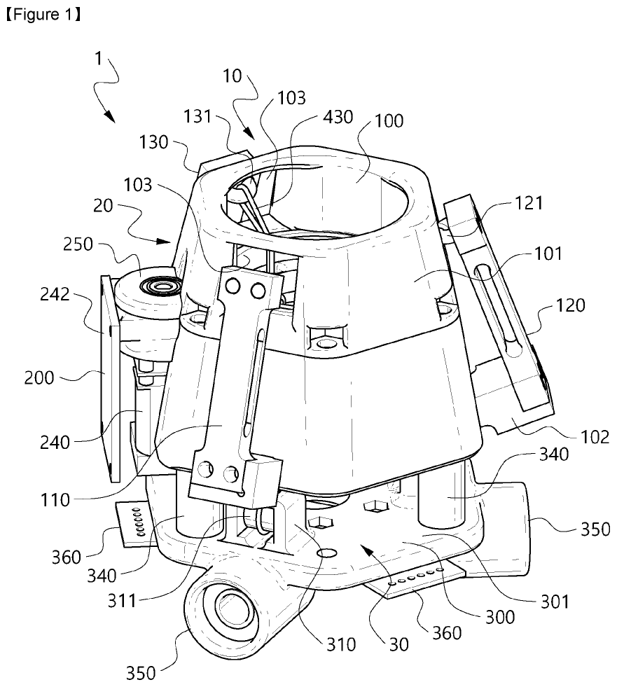

The structure of a gripper 1 according to an embodiment will be described with reference to FIGS. 1 to 3.

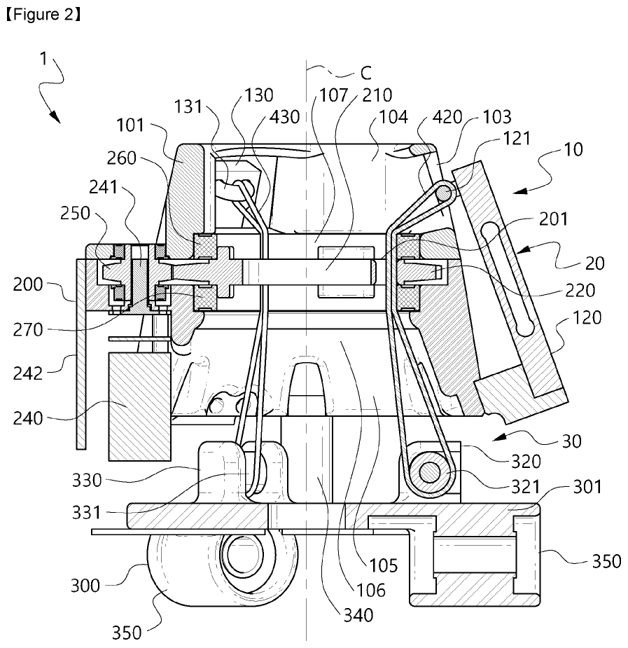

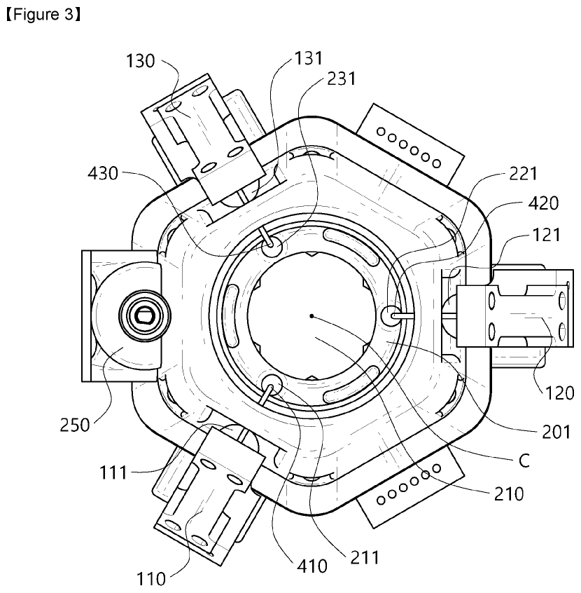

FIG. 1 is a perspective view of the gripper 1 according to an embodiment, FIG. 2 is a side cross-sectional view of the gripper 1, and FIG. 3 is a top view of the gripper 1.

As shown in FIGS. 1 to 3, the gripper 1 includes a body portion 100, an actuating portion 200 and a connection portion 300.

The body portion 100 includes a body 101 of an approximately truncated hexagonal pyramid shape, and a fixing block 102 near the bottom of three sides at an interval of 120° with respect to a center axis C of the body 101.

The body 101 has an opening 104 and an opening 105 on a top surface and a bottom surface, respectively. A hollow internal space 106 is formed between the opening 104 and the opening 105.

Here, it will be understood that the terms “top”, “middle” and “bottom” are used to describe a relative positional relationship between the components of the gripper 1, but not intended to define an absolute positional relationship with respect to the ground.

A window 103 is formed near the top of the sides of the body 101 having the three fixing blocks 102.

The lower end parts of a first load cell 110, a second load cell 120 and a third load cell 130 are fixed to the three fixing blocks 102, respectively. The first load cell 110, the second load cell 120 and the third load cell 130 are extended along approximately the sides of the body 101 such that their upper end parts arrive near the windows 103. A U-shaped bolt is formed near the upper end parts of the first load cell 110, the second load cell 120 and the third load cell 130.

According to this embodiment, the three U-shaped bolts fixed to the first load cell 110, the second load cell 120 and the third load cell 130 become a first top support point 111, a second top support point 121 and a third top support point 131 for supporting one end of elastic wires 410, 420, 430, respectively.

The first top support point 111, the second top support point 121 and the third top support point 131 are formed at the same height in the body 101, and are radially arranged at the same distance with respect to the center axis C of the body 101.

In this embodiment, the first top support point 111, the second top support point 121 and the third top support point 131 form “a first support section 10”.

The actuating portion 200 includes a rotation plate 201 disposed in the internal space 106 of the body 101, and a motor 240 to rotate the rotation plate 201.

The rotation plate 201 is disposed across the internal space 106 within a stepped portion 107 formed in the internal space 106 of the body 101, and is rotatably supported against the body 101 by bearings 260, 270 installed in the stepped portion 107.

According to this embodiment, since the body 101 has a partial hexagonal pyramid shape, the rotation center axis of the rotation plate 201 is consistent with the center axis C of the body 101.

Hereinafter, the reference sign C is affixed to both the rotation center axis of the rotation plate 201 and the center axis of the body 101, and unless otherwise stated, the rotation center axis of the rotation plate 201 and the center axis of the body 101 are not distinguished from each other. However, the rotation center axis of the rotation plate 201 and the center axis of the body 101 do not need to be consistent with each other.

The rotation plate 201 has a gear (an internal gear) 220 on the circumference. One side of the body 101 is open, and the internal gear 220 is exposed through the corresponding side.

The motor 240 is mounted on the open side of the body 101. A gear (an external gear) 250 is coupled to a rotating shaft 241 of the motor 240.

The external gear 250 and the internal gear 220 are gear connected to each other, and when the rotating shaft 241 rotates by the motor 240, the rotation plate 201 rotates around the rotation center axis C.

A motor driver 242 may control the speed and direction of the motor 240 using a processor (not shown).

As best shown in FIG. 3, the rotation plate 201 has a center hole 210 passing vertically through the rotation plate 201 at the center, and three through-holes 211, 221, 231 passing vertically through the rotation plate 201 in the radial outward direction of the center hole 210.

The center hole 210 is a hole through which the target gripped by the gripper 1 passes, and the diameter of the center hole 210 determines the diameter of the target that can be gripped. That is, the diameter of the target is smaller than the diameter of the center hole 210.

The three through-holes 211, 221, 231 form an angle of 120° with respect to the rotation center axis C of the rotation plate 201.

In this embodiment, the three through-holes 211, 221, 231 become a first middle support point 211, a second middle support point 221 and a third middle support point 231 for supporting the middle of the elastic wires 410, 420, 430, respectively.

That is, in the present disclosure, “supporting” the elastic wire does not necessarily refer to merely fixing the elastic wire, and is intended to refer to making contact with the elastic wire in the through-hole in such a way as to change the position of the elastic wire.

The first middle support point 211, the second middle support point 221 and the third middle support point 231 are formed at the same height in the body 101, and are radially arranged at the same distance with respect to the rotation center axis C of the rotation plate 201.

In this embodiment, the first middle support point 211, the second middle support point 221 and the third middle support point 231 form “a second support section 20”.

The connection portion 300 includes a body plate 301 of an approximately hexagonal plate shape, and three legs 340 extended from the upper surface of the body plate 301 to connect the body plate 301 to the lower surface of the body 101 of the body portion 100.

The center of the body plate 301 is disposed on the rotation center axis C of the rotation plate 201 (i.e., the center axis of the body 101).

A first support 310, a second support 320 and a third support 330 protrude near the three sides at an interval of 120° with respect to the rotation center axis C of the rotation plate 201 on the upper surface of the body plate 301. Rotatable pulleys 311, 321, 331 are respectively formed in the first support 310, the second support 320 and the third support 330.

In this embodiment, the three pulleys 311, 321, 331 become a first bottom support point 311, a second bottom support point 321 and a third bottom support point 331 for supporting the bottom of the elastic wires 410, 420, 430, respectively.

The first bottom support point 311, the second bottom support point 321 and the third bottom support point 331 are formed at the same height in the body 101, and are radially arranged at the same distance with respect to the rotation center axis C of the rotation plate 201.

In this embodiment, the first bottom support point 311, the second bottom support point 321 and the third bottom support point 331 form “a third support section 30”.

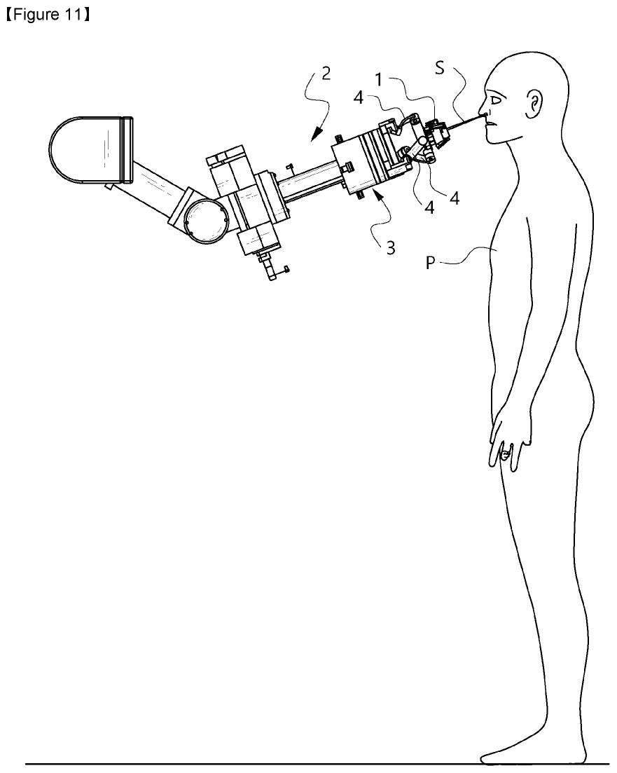

Three connection members 350 oriented in the radial direction of the body plate 301 are formed on bottom of the body plate 301. The connection members 350 are coupled to links 4 of an end effector 3 of a robot in a robot system using the gripper 1 (see FIG. 11).

A signal amplifier 360 is attached to the body plate 301 to amplify a signal of each load cell 110, 120, 130. However, the signal amplifier 360 is not necessarily formed in the body plate 301 and may be attached to any other proper location. The detection signal that has been measured by each load cell 110, 120, 130 and amplified by the signal amplifier 360 is processed by a separate processor (not shown).

According to this embodiment, when the motor 240 rotates, the rotation plate 201 rotates, and the first middle support point 211, the second middle support point 221 and the third middle support point 231 rotate around the rotation center axis C of the rotation plate 201. Since the first middle support point 211, the second middle support point 221 and the third middle support point 231 form the second support section 20, the rotation of the three middle support points around the same rotation center axis indicates “rotation of the second support section 20”. Likewise, rotation of the three top support points around the same rotation center axis may indicate “rotation of the first support section 10”, and rotation of the three bottom support points around the same rotation center axis may indicate “rotation of the third support section 30”.

When the second support section 20 rotates around the rotation center axis C of the rotation plate 201, the second support section 20 rotates relative to the first support section 10 in stationary state. However, from a standpoint of the second support section 20, it may be thought that the first support section 10 rotates relative to the second support section 20.

Additionally, actually, the rotation plate 201 may be fixed, and the first support section 10 may be configured to rotate by forming the first top support point 111, the second top support point 121 and the third top support point 131 in a drum that is rotatable relative to the body 101.

That is, the first support section 10 and the second support section 20 according to this embodiment may be configured to develop displacement relative to each other in the circumferential direction of the gripper 1, and the rotation of the first support section 10 and the second support section 20 relative to each other is referred to as “relative rotation of the first support section 10 and the second support section 20”. In this embodiment, since the first support section 10 rotates around the rotation center axis C of the rotation plate 201 relative to the second support section 20, hereinafter, the rotation center axis around which the two support sections rotate is simply referred to as “the rotation center axis C”.

Likewise, when the second support section 20 rotates around the rotation center axis C of the rotation plate 201, the second support section 20 rotates relative to the third support section 30 in stationary state.

However, from a standpoint of the second support section 20, it may be thought that the third support section 30 rotates relative to the second support section 20.

Additionally, actually, the rotation plate 201 may be fixed, and the third support section 30 may be configured to rotate by forming the first bottom support point 311, the second bottom support point 321 and the third bottom support point 331 in a drum that is rotatable relative to the body 101.

That is, the second support section 20 and the third support section 30 according to this embodiment may be configured to develop displacement relative to each other in the circumferential direction of the gripper 1, and the rotation of the second support section 20 and the third support section 30 relative to each other is referred to as “relative rotation of the second support section 20 and the third support section 30”. In this embodiment, since the third support section 30 rotates around the rotation center axis C of the rotation plate 201 relative to the second support section 20, hereinafter, the rotation center axis around which the two support sections rotate is simply referred to as “the rotation center axis C”.

In other words, according to this embodiment, the first support section 10, the second support section 20 and the third support section 30 formed in the gripper 1 rotate relative to each other around the rotation center axis C. The relative rotation of each support section may be done by independent rotation of the first support section 10, the second support section 20 and the third support section 30 by a separate motor. Alternatively, the relative rotation of each support section may be done by fixing the second support section 20 and rotating the first support section 10 and the third support section 30 by a separate motor. However, as in this embodiment, when the first support section 10 and the third support section 30 are fixed and the second support section 20 between the first support section 10 and the third support section 30 is configured to rotate, the relative rotation of the first support section 10, the second support section 20 and the third support section 30 is done by one motor, and thus it is possible to achieve simple design and it is easy to control.

Referring to FIGS. 2 and 3, the elastic wires 410, 420, 430 having elasticity are arranged across the first support section 10, the second support section 20 and the third support section 30. According to this embodiment, there are three strands of elastic wires 410, 420, 430 corresponding to the number of support points of each support section, but is not limited thereto. There may be multiple elastic wires according to the number of the first support section 10, the second support section 20 and the third support section 30.

The first elastic wire 410 is formed of a loop-shaped rubber band. The first elastic wire 410 has the top fixed to the first top support point 111 which is the U-shaped bolt, the middle passing through the first middle support point 211 which is the through-hole, and the bottom fixed to the first bottom support point 311 which is the pulley.

The second elastic wire 420 is formed of a loop-shaped rubber band. The second elastic wire 420 has the top fixed to the second top support point 121 which is the U-shaped bolt, the middle passing through the second middle support point 221 which is the through-hole, and the bottom fixed to the second bottom support point 321 which is the pulley.

The third elastic wire 430 is formed of a loop-shaped rubber band. The third elastic wire 430 has the top fixed to the third top support point 131 which is the U-shaped bolt, the middle passing through the third middle support point 231 which is the through-hole, and the bottom fixed to the third bottom support point 331 which is the pulley.

In this embodiment, a single strand of elastic wire is formed across the first support section 10, the second support section 20 and the third support section 30, but is not limited thereto.

For example, an elastic wire may be disposed across the first support section 10 and the second support section 20, and another elastic wire may be disposed across the second support section 20 and the third support section 30. In this case, the second support section 20 is not a through-hole and may be a member for fixing the end of the elastic wire by a ring formed in each of the upper and lower surfaces of the rotation plate 201.

Additionally, the elastic wire is not necessarily limited to the loop shape, and a linear wire may be supported across the first support section 10, the second support section 20 and the third support section 30. However, when the elastic wire is formed in the loop shape, from a standpoint of the target, it may obtain a gripping effect by six strands of wires, not three strands of wires, thereby improving the gripping force.

According to this embodiment, in “initial state”, the corresponding support points of the first support section 10, the second support section 20 and the third support section 30 are disposed on the same axis when viewed in the radial direction from the rotation center axis C. That is, as shown in FIGS. 1 to 3, in the initial state, the corresponding support points of the first support section 10, the second support section 20 and the third support section 30 have the same azimuth with respect to the rotation center axis C.

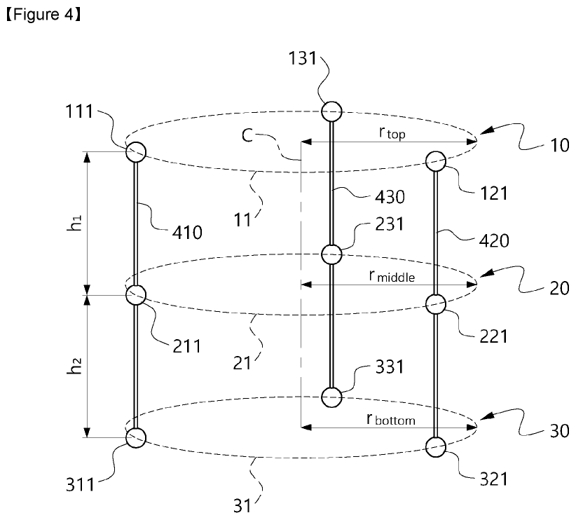

FIG. 4 is a conceptual diagram showing a conceptual configuration of the gripper 1 in the initial state.

As shown in FIG. 4, in the first support section 10, a circular area connecting the first top support point 111, the second top support point 121 and the third top support point 131, i.e., a first support area 11 having a predetermined radius rtop is defined.

In the second support section 20 spaced a predetermined distance h1 apart from the first support section 10 in the direction of the rotation center axis C, a circular area connecting the first middle support point 211, the second middle support point 221 and the third middle support point 231, i.e., a second support area 21 having a predetermined radius rmiddle is defined.

In the third support section 30 spaced a predetermined distance h2 apart from the second support section 20 in the direction of the rotation center axis C on the side opposite to the first support section 10, a circular area connecting the first bottom support point 311, the second bottom support point 321 and the third bottom support point 331, i.e., a third support area 31 having a predetermined radius rbottom is defined.

Although FIG. 4 shows that the radius rmiddle of the second support area 21 is equal to the radius rtop of the first support area 11 and the radius rbottom of the third support area 31 for convenience of illustration, the radius rmiddle of the second support area 21 is smaller than the radii of the other support areas in the embodiment of FIGS. 1 to 3. Additionally, although FIG. 4 shows that the distance h1 is equal to the distance h2, the distance h1 is smaller than the distance h2 in the embodiment of FIGS. 1 to 3. This signifies that the distance between the support areas and the radius of each support area may change as necessary, as described below.

As shown in FIG. 2, at the initial position, the first elastic wire 410, the second elastic wire 420 and the third elastic wire 430 have two ends fixed to the support points of the first support section 10 and the third support section 30 in such a tight state that they come into close contact with the outer sidewalls of the through-holes, i.e., the support points 211, 221, 231 of the second support section 20.

Additionally, in the initial state, the corresponding support points of the first support section 10, the second support section 20 and the third support section 30 have the same azimuth with respect to the rotation center axis C.

Accordingly, at the initial position, each elastic wire 410, 420, 430 is extended in a straight line when viewed in a direction facing the rotation center axis C in the radial direction of the gripper 1. Accordingly, in the conceptual structure of FIG. 4, at the initial position, each elastic wire 410, 420, 430 may be treated as a straight line shape parallel to the rotation center axis C.

In the initial state, when each elastic wire 410, 420, 430 is tightly placed in a straight line in the direction of the rotation center axis C, it is possible to prevent interferences between the target and the elastic wires 410, 420, 430 when the target enters the center hole 210 of the rotation plate 201.

Additionally, in any direction in which the second support section 20 rotates in the clockwise direction and the counterclockwise direction from the initial state, the gripping operation of the gripper 1 may be performed in the same condition (the time and the gripping force). For example, in case where the outer surface of the target is formed in a spiral shape, it may be necessary to change a direction of winding the elastic wires 410, 420, 430 around the target depending on the spiral direction. According to this embodiment, the second support section 20 may selectively rotate in any of the clockwise direction and the counterclockwise direction as necessary from the initial state, thereby making it easier to respond to the shape of the target. This effect is obtained by using the elastic wire having extendable length as the gripping member.

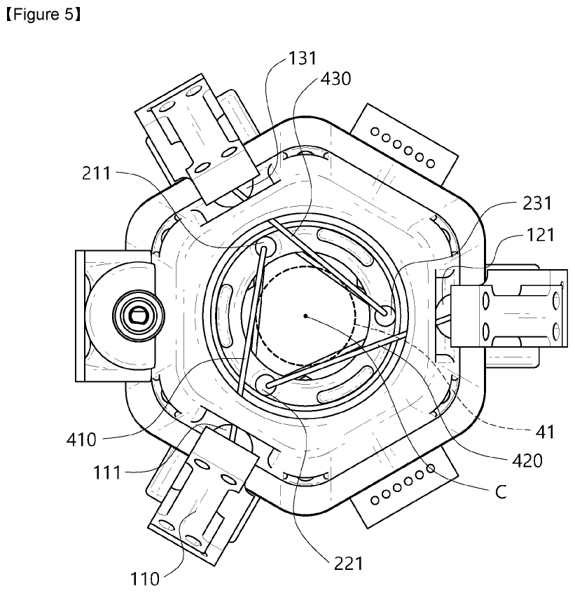

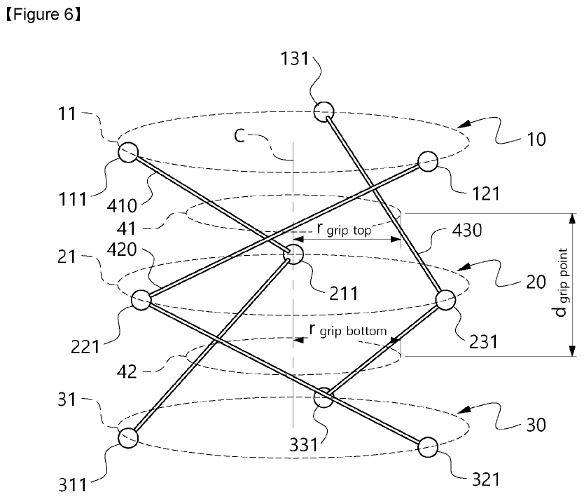

FIG. 5 is a top view of the gripper 1 when the second support section 20 is rotated by 1200 from the initial state. FIG. 6 is a conceptual diagram showing a conceptual configuration of the gripper 1 when the second support section 20 is rotated by 1200 from the initial state.

Referring to FIGS. 5 and 6, when the second support section 20 starts rotating around the rotation center axis C, each elastic wire 410, 420, 430 is pulled and stretched obliquely in the diagonal direction by the relative rotation of the first support section 10 and the second support section 20.

Referring to FIGS. 5 and 6, when viewed in a plane, the three elastic wires 410, 420, 430 converge in an approximately triangular shape, and a circular first grip area 41 having a predetermined radius rgrip top inscribed in the corresponding triangle (i.e., surrounded by the three elastic wires 410, 420, 430) is formed between the first support section 10 and the second support section 20.

The radius rgrip top of the first grip area 41 decreases with the increasing rotation angle of the second support section 20. That is, as the second support section 20 rotates, the first grip area 41 becomes narrower.

Likewise, when the second support section 20 starts rotating around the rotation center axis C, the elastic wires 410, 420, 430 are pulled and stretched obliquely in the diagonal direction between the second support section 20 and the third support section 30 by the relative rotation of the second support section 20 and the third support section 30.

A circular second grip area 42 having a predetermined radius rgrip bottom surrounded by the three elastic wires 410, 420, 430 is formed between the second support section 20 and the third support section 30 by the three converging elastic wires 410, 420, 430.

The radius rgrip bottom of the second grip area 42 also decreases with the increasing rotation angle of the second support section 20. That is, as the second support section 20 rotates, the second grip area 42 becomes narrower.

The center 51 of the first grip area 41 and the center 52 of the second grip area 42 respectively formed between the first support section 10 and the second support section 20 and between the second support section 20 and the third support section 30 are disposed on the rotation center axis C.

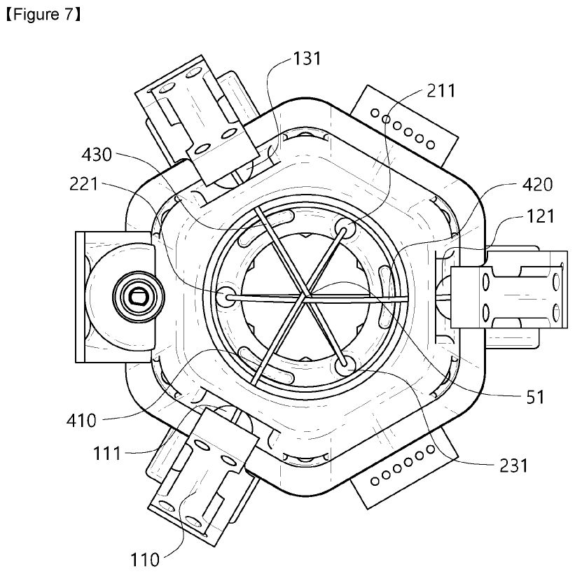

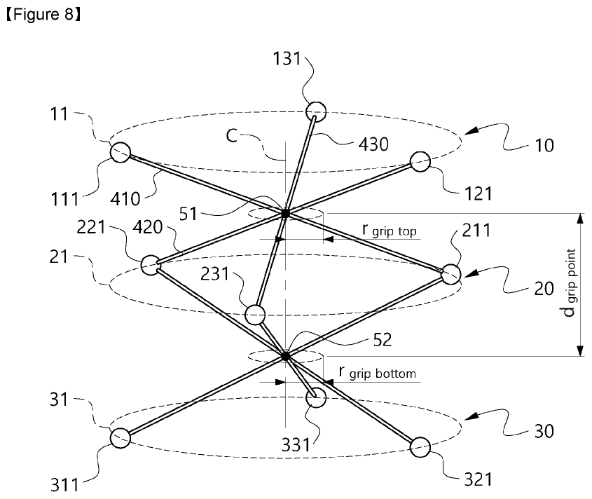

FIG. 7 is a top view of the gripper 1 when the second support section 20 is rotated by 180° from the initial state. FIG. 8 is a conceptual diagram showing a conceptual configuration of the gripper 1 when the second support section 20 is rotated by 180° from the initial state.

In the absence of the target, as the second support section 20 rotates, the first grip area 41 and the second grip area 42 become narrower, and when the second support section 20 rotates 180° from the initial state, the three elastic wires 410, 420, 430 are bent approximately 60° and twisted together when viewed in a plane. Accordingly, the radii of the first grip area 41 and the second grip area 42 are substantially 0. However, when the target is gripped, the radii of the first grip area 41 and the second grip area 42 are adjusted to the radius of the target, and are substantially non-zero.

In the absence of the target, when the radii of the first grip area 41 and the second grip area 42 are substantially 0, it signifies that it is possible to grip even a very thin object such as a needle.

According to this embodiment, the second support section 20 may rotate above 180° from the initial state.

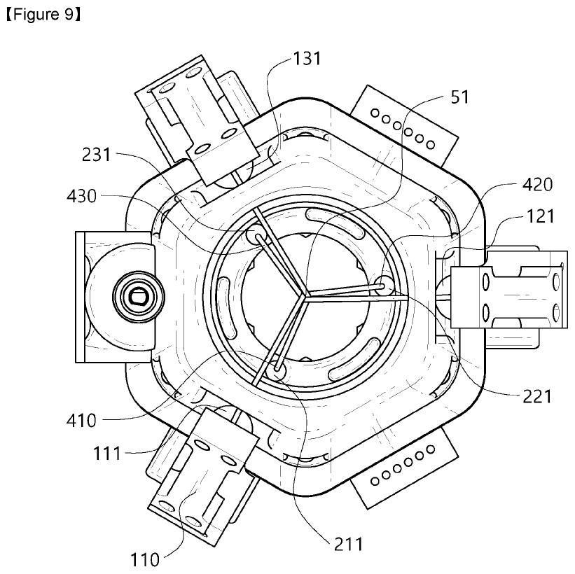

FIG. 9 is a top view of the gripper 1 when the second support section 20 is rotated by 240° from the initial state.

When the second support section 20 rotates above 180°, the three elastic wires 410, 420, 430 are further twisted around the rotation center axis C and tightened together. That is, it signifies that the gripping force increases as much, and it is possible to grip even a very thin object such as a needle with a strong force.

FIGS. 4, 6 and 8 show that the radii of the first support area 11, the second support area 21 and the third support area 31 are equal, but is not limited thereto.

When the radii of the first support area 11 and the third support area 31 are equal to each other with respect to the second support area 21, the gripping forces at the first grip area 41 and the second grip area 42 are equal. However, when the radii of the first support area 11 and the third support area 31 are different from each other with respect to the second support area 21, the gripping forces at the first grip area 41 and the second grip area 42 are different. For example, when the radius is smaller in an order of the first support area 11, the second support area 21 and the third support area 31, the gripping force at the second grip area 42 is larger than the gripping force at the first grip area 41. The size of the gripping force may be set by properly setting the radius of the first support area 11, the second support area 21 and the third support area 31.

The radii of the first support area 11, the second support area 21 and the third support area 31 may be reflected when designing the gripper 1, and may be actively changed through the configuration of the gripper 1. For example, in case where the fixing blocks 102 are configured to extend the length, the radius of the first support area 11 may be changed. Additionally, in case where the first support 310, the second support 320 and the third support 330 are configured to move the position in the direction of the rotation center axis C, the radius of the third support area 31 may be changed.

FIGS. 4, 6 and 8 show the distance h1 between the first support section 10 and the second support section 20 and the distance h2 between the second support section 20 and the third support section 30 are equal, but is not limited thereto.

When the distance h1 between the first support section 10 and the second support section 20 and the distance h2 between the second support section 20 and the third support section 30 are different, the gripping forces at the first grip area 41 and the second grip area 42 are different.

Furthermore, when any one or both of the distance h1 between the first support section 10 and the second support section 20 and the distance h2 between the second support section 20 and the third support section 30 increases, the distance between the first grip area 41 and the second grip area 42 increases, and it is possible to grip a longer target.

The distance h1 between the first support section 10 and the second support section 20 and the distance h2 between the second support section 20 and the third support section 30 may be reflected when designing the gripper 1, and may be actively changed through the configuration of the gripper 1. For example, in case where the fixing blocks 102 are configured to move up and down along the sides of the body 101, the distance h1 between the first support section 10 and the second support section 20 may be changed. Additionally, in case where the legs 340 are configured to extend the length, the distance h2 between the second support section 20 and the third support section 30 may be changed.

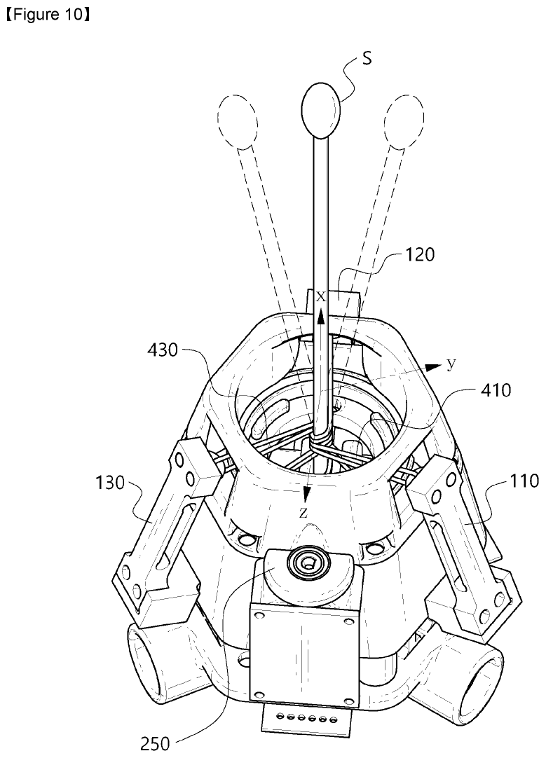

Hereinafter, the operation of gripping the target will be described in more detail with reference to FIGS. 3 to 10. FIG. 10 shows that the gripper 1 grips a swab S which is a thin and long target.

In the initial state of FIGS. 3 and 4, the swab S enters through the opening 104 of the body 101, and is inserted into the gripper 1 through the center hole 210 until the end of the swab S arrives near the opening 105 of the body 101. The operation of inserting the swab S into the gripper 1 may be performed by placing the gripper 1 closer to the swab S securely held on a holder and moving the gripper 1 to insert the swab S into the gripper 1.

Determination as to whether the swab S is sufficiently inserted into the body 101 may be made in various manners. For example, in case where the position of the swab S is known, the gripper 1 may be moved to the pre-calculated position. Alternatively, determination as to whether the swab S is sufficiently inserted into the body 101 may be made through an image of the swab S captured through a camera (not shown) installed in the gripper 1. Additionally, a laser sensor (not shown) may be installed in the gripper 1 to determine whether the swab S is sufficiently inserted into the body 101 by detecting whether the end of the swab S reached a specific location of the gripper 1.

When the swab S is sufficiently inserted into the body 101, the motor 240 operates to rotate the rotation plate 201, so that the second support section 20 rotates relative to the other support sections 10, 30.

The first grip area 41 and the second grip area 42 are formed by the rotation of the second support section 20. The second support section 20 rotates until all the three elastic wires 410, 420, 430 come into contact with the swab S, and the first grip area 41 and the second grip area 42 become narrower.

When the second support section 20 rotates by the preset rotation angle according to the diameter of the swab S, it may be determined that all the three elastic wires 410, 420, 430 come into contact with the swab S. For example, when the swab S rotates approximately 1780, gripping may start.

Alternatively, determination as to whether all the three elastic wires 410, 420, 430 come into contact with the swab S may be made by measuring the tension in the three elastic wires 410, 420, 430 stretched by the rotation of the second support section 20 using the tension sensors, i.e., the load cells 110, 120, 130, and calculating a change in tension.

In case where the swab S present in the first grip area 41 and the second grip area 42 is eccentrically disposed from the rotation center axis C, as the first grip area 41 and the second grip area 42 become narrower, some of the three elastic wires 410, 420, 430 first come into contact with the swab S. When the first grip area 41 and the second grip area 42 continuously become narrower, the elastic wires in contact with the swab S push the swab S toward the rotation center axis C.

When the first grip area 41 and the second grip area 42 become narrower by the diameter of the swab S and all the three elastic wires 410, 420, 430 come into contact with the swab S, the three elastic wires 410, 420, 430 in tight state securely hold and grip the swab S in four directions around the outer surface.

In this instance, since the center of the first grip area 41 and the center of the second grip area 42 match the rotation center axis C, the lengthwise center axis of the gripped swab S in the first grip area 41 and the second grip area 42 is aligned on the rotation center axis C.

That is, according to this embodiment, the target is automatically aligned in the center only by rotating the second support section 20 to allow the elastic wires to push the target toward the rotation center axis C. Accordingly, there is no need for an alignment operation of aligning the gripped target in the center of the gripper 1.

Additionally, since the center of the first grip area 41 and the center of the second grip area 42 match the rotation center axis C, the lengthwise center axis of the gripped swab S in the first grip area 41 and the second grip area 42 is aligned on the rotation center axis C. Accordingly, the vertical alignment of the swab S is naturally accomplished, thereby easily performing the position control of the swab S.

Since the three elastic wires 410, 420, 430 come into tight contact with the outer surface of the swab S by surface friction, it is possible to grip with a predetermined gripping force in a state that all the three elastic wires 410, 420, 430 come into contact with the swab S.

However, according to this embodiment, in order to grip the swab S with a stronger force, the second support section 20 further rotates by a predetermined angle after all the elastic wires 410, 420, 430 in contact with the swab S to allow the elastic wires 410, 420, 430 to hold and grip the swab S.

Referring to FIG. 10, substantially six strands of elastic wires grip the swab S with a strong gripping force around the outer surface of the swab S.

According to this embodiment, since the swab S is gripped by the elastic wires, when an external force is applied to the swab S, the swab S may be subjected to gradual displacement in the vertical and horizontal directions by elastic deformation of the elastic wires. That is, the gripper 1 is a soft gripper that grips the swab S softly and gently, not a hard gripper. Accordingly, it is possible to grip as if a human having soft skin grips the swab S.

Additionally, according to this embodiment, the three elastic wires 410, 420, 430 are respectively connected to the tension sensors, i.e. the first load cell 110, the second load cell 120 and the third load cell 130.

As shown in FIG. 10, when a bending displacement occurs to the swab S by the action of the external force on the swab S, tension is generated by elastic deformation of the elastic wires 410, 420, 430 wound around the swab S. A tension change of the elastic wires 410, 420, 430 causes displacement of each load cell, and the tension of the connected elastic wires may be detected by each load cell.

The direction and size of the external force acting on the swab S may be detected with respect to the x-y-z coordinate axes set in the gripper 1 by summing the detection values of the three load cells 110, 120, 130. The detected direction and size of the external force may be used to precisely control the swab S as haptic feedback.

The gripper 1 according to this embodiment may be used in robot systems all over the industrial sectors. FIG. 11 shows an example of the robot system using the gripper 1.

The robot system according to this embodiment is a specimen collection robot system for collecting the specimen from the nasal mucosa of the subject P.

The robot system includes a multi-articulated robotic arm 2 and the end effector 3 mounted at the tip of the robotic arm 2. The end effector 3 includes the plurality of links 4, and the plurality of links 4 is coupled to the connection members 350 of the gripper 1. The position and pose of the gripper 1 is controlled by the operation of the links 4 of the end effector 3.

The robot system grips the swab S by use of the gripper 1, inserts the swab S into the nose of the subject P, and slides the swab S in contact with the nasal mucosa of the subject P to scrape and collect the specimen.

This operation is performed in the human body, and it is necessary to minimize injury or discomfort to the subject P while moving the swab S.

Since the gripper 1 according to this embodiment softly grips the swab S, in practice, it is possible to realize feeling as if a medical profession having soft skin directly grips the swab S. Furthermore, since the swab S is allowed to softly move in contact with the nasal mucosa, it is possible to avoid injury or discomfort to the subject P.

Additionally, since the external force acting on the swab S may be detected using the tension sensors, it is possible to achieve precise control to prevent the application of an excessive force when scraping the nasal mucosa with the swab S using the feedback information.

Additionally, the gripper 1 according to this embodiment may grip any target having a smaller radius than the radii of the support areas 11, 21, 31 irrespective of the radius of the target. That is, it is possible to ensure target compatibility.

In general, the specimen collection process is performed by collecting the specimen from the subject's nasal cavity with the swab, breaking the swab, putting it in the reagent tube, closing the lid of the reagent tube and placing in a predetermined location. Accordingly, the specimen collection robot system may grip the reagent tube, rather than the swab S. In general, the diameter of the reagent tube is larger than the diameter of the swab.

According to this embodiment, it is possible to selectively grip the swab S and the reagent tube using one robotic arm 2 and the gripper 1 without replacing the gripper 1 or using another robotic arm, and since the specimen collection process may be performed using the single robotic arm, it is possible to simplify the architecture of the robot system.

What is claimed is:

1. A gripper for gripping a target, comprising:
a first support section;
a second support section spaced apart from the first support section in a direction of a rotation center axis; and
a plurality of elastic wires supported across the first support section and the second support section,
wherein a first grip area surrounded by the plurality of elastic wires is formed between the first support section and the second support section upon a relative rotation of the first support section and the second support section around the rotation center axis, and
wherein the first grip area becomes narrower until all the plurality of elastic wires comes into contact with the target by the relative rotation of the first support section and the second support section, and the plurality of elastic wires is tightened to grip the target entering the first grip area.

2. The gripper according to claim 1, further comprising:
a third support section spaced apart from the second support section on a side opposite to the first support section,
wherein the plurality of elastic wires is supported across the first support section, the second support section and the third support section,
wherein a second grip area surrounded by the elastic wires is formed between the second support section and the third support section upon a relative rotation of the second support section and the third support section around the rotation center axis, and
wherein the second grip area becomes narrower until all the plurality of elastic wires comes into contact with the target by the relative rotation of the second support section and the third support section, and the plurality of elastic wires is tightened to grip the target entering the second grip area.

3. The gripper according to claim 2, wherein a center of the first grip area and a center of the second grip area are disposed on the rotation center axis, and
wherein the target is centrally aligned on the rotation center axis, and the target is gripped with a lengthwise direction aligned vertically in parallel to the rotation center axis.

4. The gripper according to claim 3, wherein the second support section rotates relative to the first support section and the third support section in stationary state upon rotating.

5. The gripper according to claim 4, wherein each elastic wire is extended in a straight line at an initial position, when viewed in a direction facing the rotation center axis in a radial direction of the gripper, and
wherein each elastic wire is supported in tight state at the initial position.

6. The gripper according to claim 5, wherein the second support section is rotatable 180° or more relative to the first support section and the third support section from the initial position.

7. The gripper according to claim 6, wherein the second support section further rotates a predetermined angle after all the plurality of elastic wires comes into contact with the target, and
wherein the plurality of elastic wires is wound around the target to increase a gripping force.

8. The gripper according to claim 1, further comprising:
a plurality of tension sensors to detect tension acting on the plurality of elastic wires, respectively,
wherein a size and direction of an external force acting on the target is detected by summing the tension detected by the plurality of tension sensors.

9. The gripper according to claim 8, wherein the tension sensor is a load cell connected to a support point at which an end of each of the plurality of elastic wires is fixed in the first support section.

10. The gripper according to claim 2, wherein a radius of a first support area defined in the first support section, a radius of a second support area defined in the second support section, and a radius of a third support area defined in the third support section are different.

11. The gripper according to claim 2, wherein a distance between the first support section and the second support section and a distance between the second support section and the third support section are different.

12. A robot system, comprising:
the gripper according to claim 1;
an end effector connected to the gripper to change a pose and position of the gripper; and
a robotic arm in which the end effector is mounted at a tip.
